(19) United States
(12) Patent Application Publication
(10) Pub. No.: US 2017/0010179 A1
(43) Pub. Date: Jan. 12, 2017

(54) ADJUSTABLE WIDE BANDWIDTH GUIDEDWAVE (GW) PROBE FOR TUBE AND PIPE INSPECTION SYSTEM

(71) Applicants: Eyal Conforti, Tel Aviv (IL); Peter Sirkis, Netanya (IL); Dov Furman, Rehovot (IL)

(72) Inventors: Eyal Conforti, Tel Aviv (IL); Peter Sirkis, Netanya (IL); Dov Furman, Rehovot (IL)

(21) Appl. No.: 15/185,001

(22) Filed: Jun. 16, 2016

Related U.S. Application Data
(60) Provisional application No. 62/181,188, filed on Jun. 17, 2015.

(51) Int. Cl. G01M 5/00; G01N 29/24; G01N 29/04

(52) U.S. Cl. CPC G01M 5/0025; G01N 29/043; G01M 5/0033; G01N 29/24; G01N 2291/2636

(57) ABSTRACT

A hand held portable device used for conducting inspections of tubes. The hand held portable device interfaces to a tube through an adjustable centering mechanism to ensure that the central axis of the hand held portable device is proximate to the central axis of the tube to be inspected. This can be accomplished by using a conical shaped insertion element or, movable guides that can be pressed against an interior surface of a tube to be inspected.

### CROSS-REFERENCE TO RELATED APPLICATIONS

The present application is related to U.S. patent application Ser. No. 14/641,418 that claims priority to the U.S. provisional patent application Ser. No. 61/950,158 filed on Mar. 9, 2014 and is related to a Patent Cooperation Treaty application (PCT) application number PCT/IL2013/000054 that was filed in the Israeli Receiving Office on Jun. 10, 2013, the contents of each of these are incorporated herein by reference.

### FIELD OF INVENTION:

The present disclosure relates to the field of non-destructive testing and more particularly, the present disclosure is in the technical field of tube and pipe inspection for the assessment of their condition, anomalies, weaknesses and to facilitate their repair.

### DESCRIPTION OF BACKGROUND ART

There are several techniques that are presently in use for conducting inspections of tubes and/or pipes. These techniques can be divided into two main groups: traversing and non-traversing. The traversing methods employ a probe, which can inspect only the portion of the tube in its immediate vicinity. In order to inspect an entire tube, the probe is tethered to a cable by which the probe is pushed all the way down from one end of the tube to the other and then pulled back. Traversing methods are slow, prone to wear and tear of the probe, and eventual failure. One example of a traversing inspection method is Eddy Current Testing, and related methods such as Remote Field Testing and Magnetic Flux Leakage testing. All these traversing methods are electromagnetic methods, having varying degrees of accuracy. Another example is the widely known as IRIS (Internal Rotating Inspection System), which is based on ultrasound. IRIS is based on the use of a probe that scans the tube wall in a spiral manner using an ultrasound beam propagating in water. The IRIS method is much slower than the electromagnetic methods and requires cleaning the tube wall down to the metal, which is an expensive process. Throughout this disclosure, the terms tube and pipe can be used interchangeably and the term tube can be used as representative term for both terms.

Non-traversing methods are based on inserting a probe a relatively short distance into a tube under test, and then applying a physical method for inspecting the entire tube from this location. As a non-limiting example of such a method is Acoustic Pulse Reflectometry (APR). In the APR method, an acoustic signal (which could be, for example, but not limited to a pulse or a pseudo noise signal, swept sine, etc.) is propagated through the air inside the tube. Any changes in the cross sectional profile of the tube creates reflections, which propagate back down the tube toward the probe where they can ultimately be recorded and later analyzed. APR gives good results in detecting anomalies on the interior surface or cross-sectional profile of a tube, such as blockages, through holes, and circumferential changes in cross section of a tube. APR has several advantages: APR is fast, it can accurately assess blockages, and it is very sensitive to through-holes, for example. A reader who wishes to learn more about APR systems is invited to read U.S. Pat. No. 7,677,103, or US pre-granted publication number US2011-0166808, or U.S. Pat. No. 8,960,007.

An inspection method, which is commonly known to those skilled in the relevant art as the Guided-Wave (GW) method, is based on propagating mechanical waves within the tube wall itself. These waves can be, for example but not limited to, a torsional or longitudinal or flexural wave, and the excitation signal can be for example, but not limited to, a pulse or a pseudo noise signal, swept sine, etc. The torsional waves are marked with the letter ‘T’; the longitudinal waves are marked with the letter ‘L’; the flexural waves are marked with the letter ‘F’. Torsional waves are those in which particle displacement is in the circumferential direction, but the wave propagates down the axis of the tube. Longitudinal waves are those in which the particle displacement is in the axial direction, similarly to the direction of propagation of the wave. Particle displacement in torsional waves and longitudinal waves is independent of the azimuthal angle, therefore they are axisymmetric. Each type of the above waves are associated with:
An infinite number of higher order axisymmetric modes, depending on the number of nodal surfaces through the thickness of the tube wall, denoted T(0,m), m=1,2,3, . . . for torsional modes and L(0,m), m=1,2,3 . . . for longitudinal modes; These modes have different cut-on frequencies and different dispersion curves.
A doubly infinite number of non-axisymmetric modes, denoted F_{T}(n,m)—where n=1,2,3 . . . and m=1,2,3 . . . . for flexural modes associated with torsional waves, and F_{L}(n,m)—where n=1,2,3 . . . and m=1,2,3 . . . . for flexural modes associated with longitudinal waves. These modes have different cut-on frequencies and different dispersion curves.

Different modes of excitation are well known to a person having ordinary skill in the art and will not be further described. A reader who wishes to learn more about mechanical waves is invited to read technical documents such as but not limited to the article “Flexural torsional guided wave mechanics and focusing in pipe”, Journal of Pressure Vessel Technology Vol. 127, November 2005, pp. 471-478 written by Zongqi Sun, Li Zhang, Joseph L. Rose, for example.

Interfacing to the tube can be accomplished from the interior of the tube by inserting a GW probe with one or more GW transducers in one of the openings of the tube. Alternatively the interfacing with a tube can be accomplished externally by associating one or more GW transducers with the outer circumference of the tube.

The GW technique is sensitive to the degree of material loss. Any changes in the tube wall properties or dimensions will create a reflection, which can be recorded and analyzed. GW is fast and sensitive to flaws on both the outside and inside surfaces of the tube. Typically GW inspection systems have limited bandwidth (BW).

### SUMMARY OF THE DISCLOSURE

In order to detect small defects in a tube, an excitation of high frequencies having short wavelengths is needed. For example, mechanical waves with frequencies above 200 KHz may be needed in order to detect defects having a length of 2-3 millimeters. Further, in order to achieve high resolution and accurate sizing, GW systems need to be broadband from low frequencies up to high frequencies, for example from 20 kHz up to 400 kHz. One of the challenges in obtaining large bandwidth is in exciting only the desired modes. However, the scattering caused by defects excites many unwanted modes. Therefore another challenge in achieving a large bandwidth is to filter out these unwanted modes. Some embodiments of the present disclosure achieve a large bandwidth by precise location of the transducers on the circumference of the tube.

It is well known to a person with ordinary skill in the relevant art that exciting mechanical waves in tubes is associated with excitation of a plurality of modes such as T, L and F_{L} and F_{T} etc. Some of these modes interfere with the desired measurement and are therefore termed “unwanted modes”. The unwanted modes may be generated in the inspected tube in addition to the wanted modes.

For example in order to use mode T(0,1) as the wanted mode, an embodiment of the system can transmit substantially the same signal simultaneously from all transducers on a ring of N transducers. The transducers can be distributed substantially evenly on the circumference of the tube being inspected. However, in such a case, a plurality of unwanted modes will be excited. The dominant unwanted modes interfering with the measurement may include: F_{T}(N,1); F_{T}(2N,1) . . . ; F_{L}(N,1); F_{L}(2N,1); . . . ; etc. . . . For example, using six transducers on each ring can excite unwanted modes F_{T} (6,1), F_{L}(6,1), F_{T}(12,1), F_{L}(12,1), T(0,2), F_{L}(6,2), . . . etc. If these modes are not suppressed relatively to the wanted signal, the interpretation of the measured signal will be ambiguous and defects may be masked. The cut-on frequency of these unwanted modes is generally monotonic with the index ‘N’ given above. In the present disclosure and the claims the terms measure, inspect, monitor, test, check, etc. can be used interchangeably.

In other embodiments other modes can be used as the wanted modes. For example, in order to use mode F_{T} (1,1) as the wanted mode, an embodiment of the system can transmit weighted versions of substantially the same signal simultaneously from all transducers on a ring of N transducers. The weights can be sin(2πk/N) where k is the transducer index along the circumference, and can be equal to k=0,1 . . . N-1. For example, using six transducers on each ring can excite unwanted modes F_{T} (5,1), F_{T} (7,1), F_{L}(5,1), F_{L}(7,1), . . . etc. In a similar way, other embodiments may select other modes as the wanted mode.

Therefore, for the cut-on frequencies of the unwanted modes to be beyond the desired bandwidth's upper limit, a large number of transducers (N) is needed. Thus, it increases the available spectral bandwidth without unwanted modes. Consequently, one technique to avoid the presence of these modes in the desired frequency band, can involve increasing the number of transducers around the tube circumference. When inspecting narrow gauge tubes, such as those typically found in heat exchangers, it is difficult to fit a sufficient number of transducers into the limited space available. In addition, the cost of the transducers may also play a role for wide gauge pipes.

In addition to having a large number of transducers, an example embodiment of a GW probe is configured to place each one of the transducer at precise locations circumferentially in relation to the other transducers. In some embodiments of GW probes, the GW transducers are placed at equidistant locations around the circumference. Embodiments of a GW probe may comprise a mechanism that enables rapid pressing of the GW transducers against the tube wall and then rapid release, while ensuring that the GW transducers are placed as precisely as possible.

Some embodiments of the GW probe are configured to place both ends of the assembly containing the GW transducers concentric within the tube being inspected. Further, embodiments of GW probe are configured to enforce the movement of the transducers, within the probe, only in the radial direction, creating a substantially concentric circle with the tube.

Some example embodiments of the novel GW probe are configured to support the weight of the elements that remain out of the tube also, so that despite any torque those elements apply on the assembly internal to the tube, the placement of the sensors will be affected as little as possible.

The above-described deficiencies of GW methods, do not limit the scope of the inventive concepts of the present disclosure in any manner. The deficiencies are presented for illustration only.

In the following description, for purposes of explanation, numerous specific details are set forth to assist in the understanding of the various embodiments and aspects of inventions presented within this document. It will be apparent, however, to one skilled in the relevant art that embodiments of the invention may be practiced without some or all of these specific details. In other instances, structures and devices are shown in block diagram form to avoid obscuring the flexibility and variability of the embodiments of the invention. References to numbers without subscripts or suffixes are understood to reference all instances of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter.

Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

Although some of the following description is written in terms that relate to software or firmware, embodiments may implement the features and functionality described herein in software, firmware, or hardware as desired, including any combination of software, firmware, and hardware. In the following description, the words “unit,” “element,” “module” and “logical module” may be used interchangeably. Anything designated as a unit or module may be a stand-alone unit or a specialized or integrated module. A unit or a module may be modular or have modular aspects allowing it to be easily removed and replaced with another similar unit or module. Each unit or module may be any one of or any combination of software, hardware, and/or firmware, ultimately resulting in one or more processors programmed to execute the functionality ascribed to the unit or module. Additionally, multiple modules of the same or different types may be implemented by a single processor. Software of a logical module may be embodied on a computer readable medium such as a read/write hard disc, CDROM, Flash memory, ROM, or other memory or storage, etc. In order to execute a certain task a software program may be loaded to an appropriate processor as needed. In the present disclosure the terms task, method, process can be used interchangeably.

These and other aspects of the disclosure will be apparent in view of the attached figures and detailed description. The foregoing summary is not intended to summarize each potential embodiment or every aspect of the present disclosure, and other features and advantages of the present disclosure will become apparent upon reading the following detailed description of the embodiments with the accompanying drawings and appended claims.

Furthermore, although specific exemplary embodiments are described in detail to illustrate the inventive concepts to a person skilled in the art, such embodiments are susceptible to various modifications and alternative forms. Accordingly, the figures and written description are not intended to limit the scope of the inventive concepts in any manner.

### BRIEF DESCRIPTION OF THE DRAWINGS

Some examples of embodiments of the present disclosure will be understood and appreciated more fully from the following detailed description, taken in conjunction with the drawings in which:

FIG. 1A illustrates a front end of an example of hand-held probe (HHP) associated with a transducer cylinder (TC) that comprises a centering mechanism;

FIG. 1B shows a side view of an example of a conical-centering mechanism (CCM) that comprises one or more stepwise-conical elements;

FIG. 1C shows a cross section view of the CCM of FIG. 1B;

FIG. 2A and FIG. 2B illustrate two states of an adjustable centering mechanism (ACM) 200 for centering a transducer cylinder 210. The ACM 200 can be located at the far end of the transducer cylinder 210;

FIG. 3A and FIG. 3B illustrate example elements of a transducer cylinder (TC) 300 having two virtual rings (VR) of GW transducers, wherein the VRs are at a first state and wherein each VR is associated with another example of an ACM;

FIG. 4A and FIG. 4B show example elements of the TC 300 of FIG. 3A and FIG. 3B, wherein the VRs are at a second state;

FIG. 5 shows relevant elements of an example of a GW tube inspection system; and

FIG. 6 is an exemplary flowchart diagram with relevant actions of an example process for attaching-detaching process of an example of HHP with a tube.

### DETAILED DESCRIPTION OF VARIOUS EMBODIMENTS

Turning now to the figures in which like numerals represent like elements throughout the several views, different embodiments of a tube inspection system, as well as features, aspects and functions that may be incorporated into one or more such embodiments, are described. For convenience, only some elements of the same group may be labeled with numerals. The purpose of the drawings is to describe different exemplary embodiments as well as features and aspects that can be incorporated into various embodiments and not for production. Therefore, features shown in the figures are chosen for convenience and clarity of presentation only. It should be noted that the figures are for illustration purposes only and are not necessarily drawn to scale. Moreover, the language used in this disclosure has been principally selected for readability and instructional purposes, and may not have been selected to delineate or circumscribe the inventive subject matter, resort to the claims being necessary to determine such inventive subject matter.

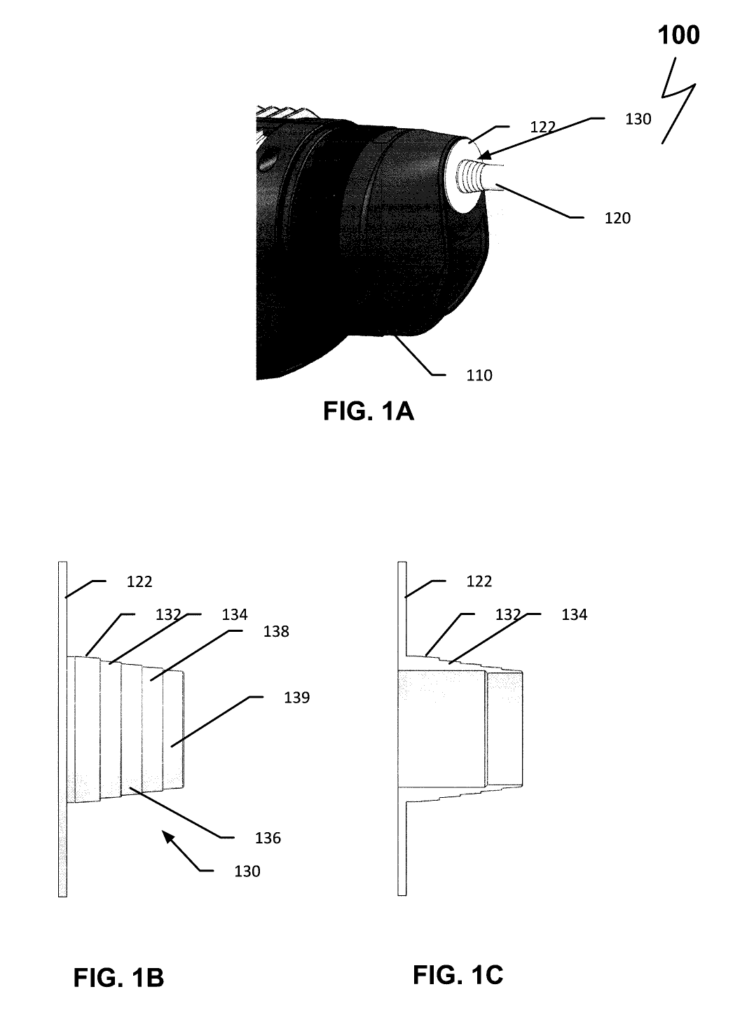

FIG. 1A shows perspective view of a front end of an exemplary hand-held probe (HHP) 100 includes a body or housing 110 associated with a transducer cylinder (TC) 120 that comprises a conical-centering mechanism (CCM) 130. The illustrated exemplary embodiment of the CCM 130 comprises one or more stepwise conical elements 132, 134, 136, 138 and 139 (reference to FIG. 1B and FIG. 1C) at the near end 122 of the TC 120 that is attached to the body 110 of the HHP 120.

In order to associate the HHP 100 with a tube, the TC 120 may be pushed into the tube up to one of the conical elements 132, 134, 136, 138 and 139 (FIG. 1B and FIG. 1C), this one conical element can be referred as the matched-conical element (MCE). The outer diameter of the MCE can be substantially similar to inner diameter of the opening of the tube. The conical structure of each of the relevant element forces the TC 120 to be concentric within the tube. Thus, the number of steps 132, 134, 136, 138 and 139 (FIG. 1B and FIG. 1C) and the conical shape of each step give a degree of freedom that enables a single TC 120 to inspect tubes having different diameters.

The angle of each segment 132, 134, 136, 138 and 139 (FIG. 1B and FIG. 1C) is such that given the material of this element, and that of tube being inspected, and the coefficient of friction between them, when the probe is inserted into the tube, the friction will hold it stationary even if the hand held unit is left to hang on its own weight.

In some embodiments of the HHP 100 the TC 120 can be permanently affixed to the HHP 100. In other embodiments of the HHP 100 the TC 120 can be detachably affixed. The hand-held probe 100 can include or be coupled with a plurality of different sizes of transducer cylinders 120, wherein each transducer cylinder could fit a different internal diameter of an inspected tube.

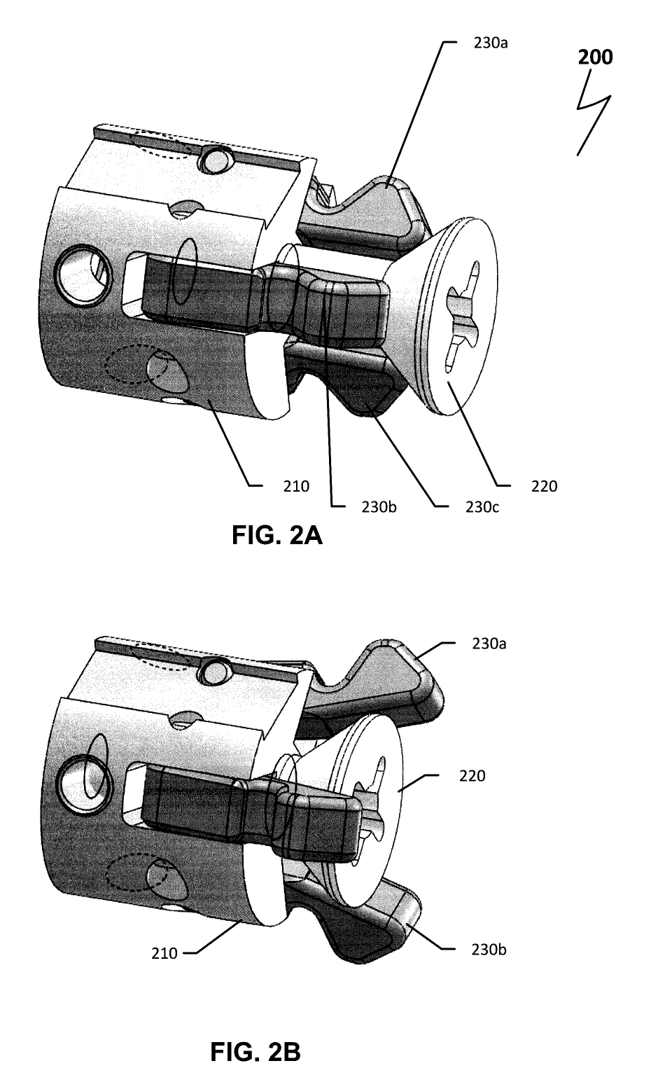

FIG. 2A and FIG. 2B illustrate an example of a centering mechanism 200 located at the far end of the TC 210. Three guides 230a, b and c with rounded surfaces facing out from the probe, towards the inner surface of a tested tube, maintain the far end of the probe concentric with the tube. The centering mechanism 200 is adjustable by a pushing screw 220. The pushing screw 220 can be configured to push, when it is rotated clockwise, the guides 230a, b and c out to the required distance, as it is illustrated by FIG. 2B. When the pushing screw 220 is rotated counterclockwise, the guides 230a, b and c can return to the center of probe 210 as in FIG. 2A.

The angle and the material at the top of each guides 230a,b&c can be selected to create sufficient friction for holding the HHP stationary in the interior of the tube even when it is left unsupported by the operator. Before inserting the TC 210 into the tube, the pushing screw 220 can be rotated clockwise pushing the guides 230a, b and c toward a position that matches the interior diameter of the opening of the tube allowing the penetration of the TC 210 into the tube. In this position, the distance between the top of each of the guides 230a b and c and the central axis of the TC 210 is substantially equal but smaller than the radios of the tube. The distance can be in between 85% to 95% of the radius of the tube, for example.

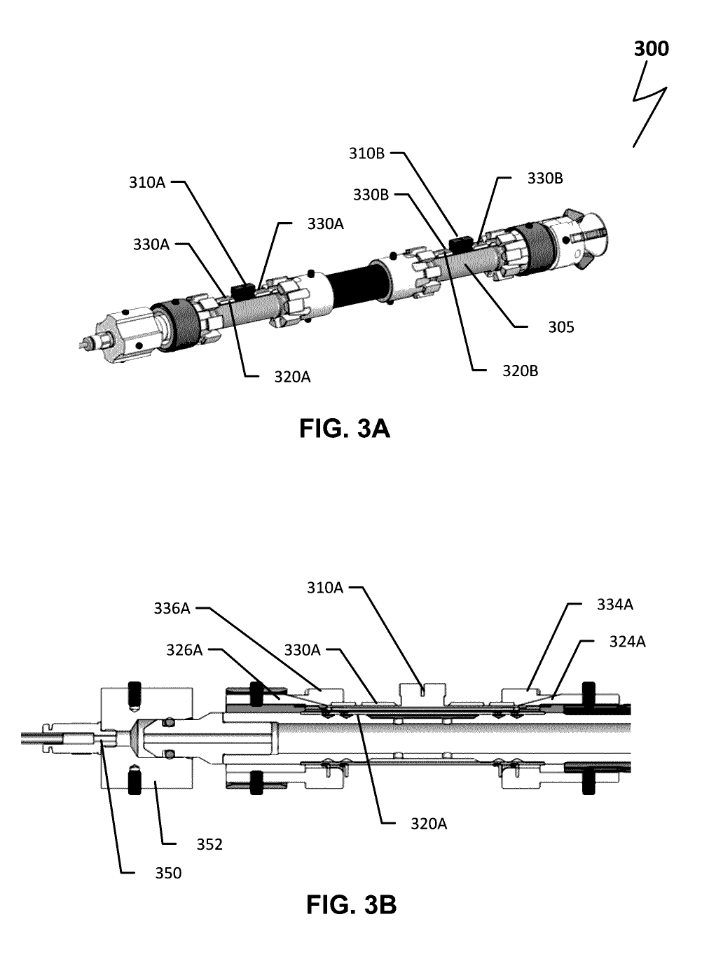

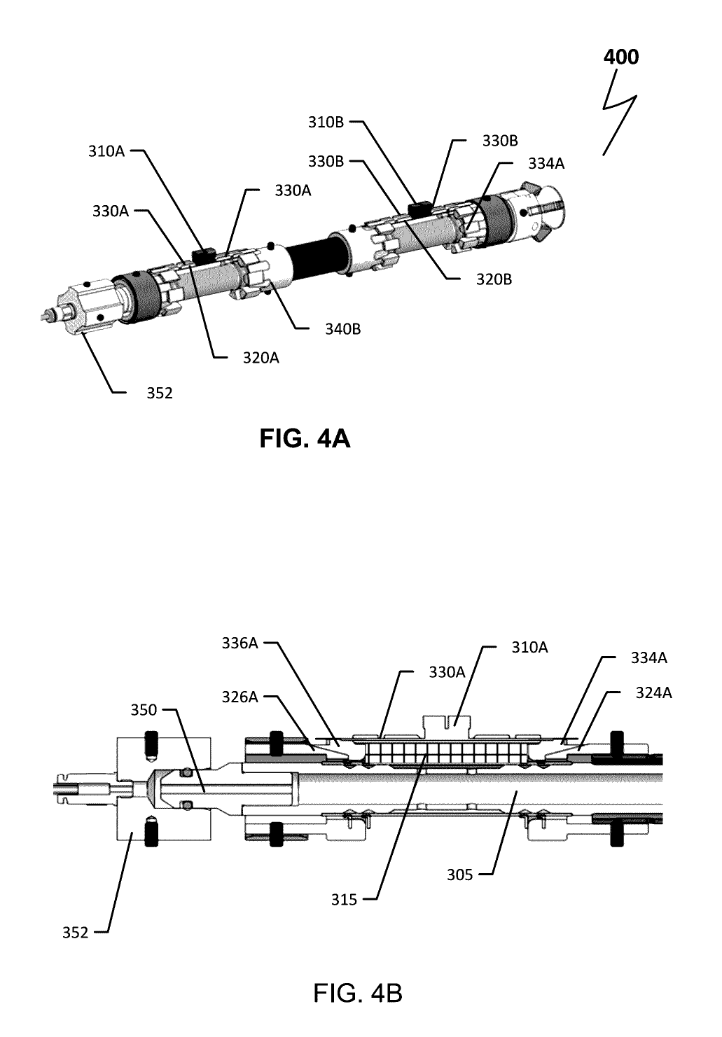

FIG. 3A and FIG. 3B, as well as FIG. 4A and FIG. 4B show two states of another embodiment of an ACM that is configured to ensure radial movement of the transducers. FIG. 3A and FIG. 3B illustrate the non-active state (NAS) 300 and FIG. 4A and FIG. 4B illustrate the active state ring (ASR) 400 when the TC 400 is inside and be associated with a tube.

The radial movement, of the transducers, maintains the circumferential location of the transducers 310A and 310B when the TC is associated with the tube. Each transducer 310A and 310B can be located on a flexible printed circuit 330A and 330B (respectively) that goes through a rigid U-beam 320A 320B, respectively. Each edge of a beam is held in a gear-like mechanism 336A and 326A as well as 334A and 324A with radial slots having parallel walls and sloped shoulders 326A and 324A. In some embodiments in which the U-beam moves in and out, it is constrained to move only in the radial direction. In some embodiments a locking mechanism can be located at the far end of the entire TC 300 a locking mechanism is illustrated 350 and 352 for securing the elements of TC 300 at their place.

In some embodiments, each one of the gaps: between 320A and the main body 305 as well as the gap between 320B and the main body 305 can comprise an elevating mechanism 315 (FIG. 4B). The elevating mechanism 315 can be configured to cause the rigid U-beam 320A and 320B to move up (far from the main body 305), as it is illustrated by FIG. 4A and FIG. 4B, increasing the diameter of the virtual ring of the transducers 310A and 310B, as illustrated by FIG. 4A and FIG. 4B, in order to push the transducers 310A and 310B toward the internal walls of a tube into an active state.

In some embodiment of the present disclosure, the elevating mechanism 315 (FIG. 4B) can comprises a balloon having a shape of a ring located between the virtual ring of the transducers 310A and 310B and the main body 305. In some embodiments, a feedback mechanism can be associated with the elevating mechanism. The feedback mechanism can be used to detect that the ring of the transducers matches the internal diameter of the tube. An example of such a feedback mechanism can monitor the pressure that exists in the balloon while the transducers are pushed toward the tube walls.

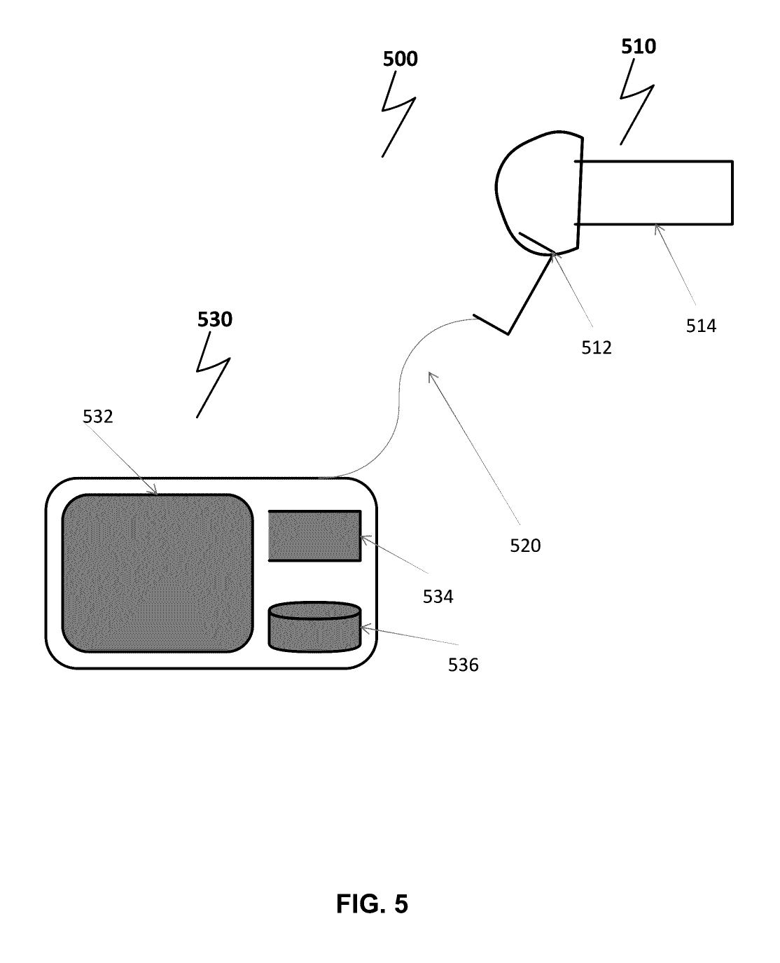

FIG. 5 shows relevant elements of an example of a tube inspection system 500. System 500 may comprise an HHP 510 having a housing 512 and a TC 514, a main processing unit (MPU) 530 and a cable 520 that connects the HHP 510 and the MPU 530. In some embodiments the TC 514 can be removable, which can be replaced with another TC having a different diameter. The appropriate TC 514 can be selected according to the internal diameter of a tube to be inspected next.

In more detail, the housing 512 is used to insert the transducer cylinder 514 into the interior of a tube under inspection. Next, an example of an adjustable centering mechanism (ACM) can be activated in order to push the virtual ring of the transducers toward the wall of the tubes. As results of elevating the transducers from the main body 305, the TC can be associated with the internal surface of inspected tube holding the HHP at its position. In some embodiments the ACM can be the one that is illustrated in FIG. 2A& and FIG. 2B. Other embodiments of the HHP 510 may have the ACM that is illustrated in FIG. 3A and FIG. 3B as well as FIG. 4A and FIG. 4B.

After pushing the virtual ring of the transducers toward the wall, a sequence of measurements can be initiated. One or more of transducers 310A on the first virtual ring can serve as actuators that function to create the mechanical GW, while the transducers 310B on the other ring serve as receivers, for example. All received mechanical signals are converted into electronic signals by the one or more transducers 310B of the second ring. The electronic signals can be transmitted or communicated to the main processing unit (MPU 530), via cable 520, where they can be processed and stored.

In some embodiments, a detachable transducer cylinder 514 can have a shape of a cylinder with a near end and a far end. The external diameter of the cylinder 514 is less than the internal diameter (ID) of the tube under inspection. The near end of the detachable transducer cylinder 512 can comprise an example of the conical-centering mechanism (CCM) 130 (FIG. 1A, FIG. 1B and FIG. 1C). The illustrated example of the CCM 130 comprises one or more stepwise conical elements 132, 134, 136, 138 and 139 (FIG. 1B and FIG. 1C) at the near end of the TC 514 that is attached to the body 512 of the HHP 510. A plurality of detachable transducer cylinders can be associated with the HHP 510. Each detachable transducer cylinder 514 can relate to a certain range of diameters of an inspected tube.

The MPU 530 can generate and transmit, via the cable 520, the electrical excitation signals toward the GW elements (transducer 310A and 310B in FIG. 3A, FIG. 3B, FIG. 4A and FIG. 4B, for example). The received electronic signals from the transducers can be carried over cable 520 toward the MPU 530 in order to be processed and stored.

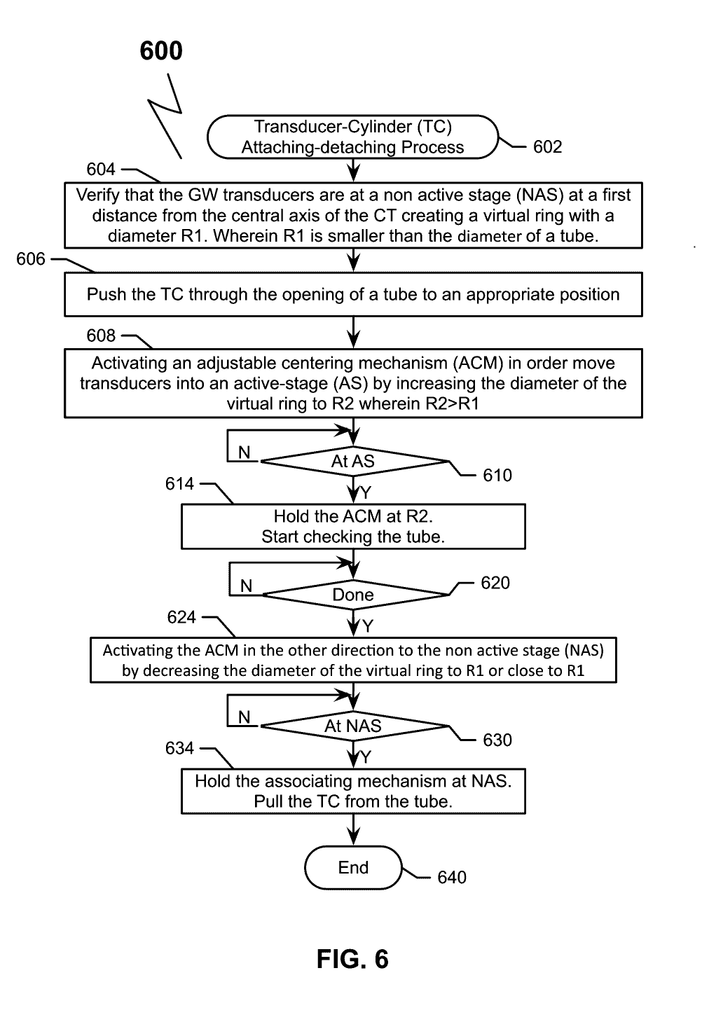

In some embodiments, the cable 520 can comprise pressure and/or vacuum lines for pressing mechanism ACM 200 or the leading screw 350 to be actuated and thus press the transducers 310A and 310B against the interior wall of the tube under inspection. The MPU 530 may comprise a storage medium 536 for recording the signals, software, reports, etc. In addition, the MPU 530 may comprise a processor 534. The processor 534 can be loaded from the storage medium 536 with software to execute the necessary processes for measuring the condition of the inspected tube, collecting the obtained signals, processing them, analyzing them, and delivering reports or output information to a display 532, for example. An example of such a process is disclosed below in conjunction with FIG. 6. The display unit 532 can be used as an interface between a user and the MPU 530. In addition MPU 530 can be connected to a printer (not shown in the drawings) in order to deliver printed reports.

Referring now to FIG. 6, which illustrates a flowchart with relevant actions of an exemplary attaching-detaching process 600 of an exemplary TC 120 of an HHP 100 (FIG. 1) with a tube under test. Process 600 can be implemented by a main-processing unit (MPU) 530 that mange the tube inspection process. The process can be initiated 602 by a user after associating an appropriate transducer cylinder 514 with the housing 512 of the HHP 510 (FIG. 5). The user can load the MPU 530 with information about the inspected tube (not shown in the figures), the transducer cylinder 514 (FIG. 5), the bundle (if the tube is in a bundle of tubes), etc. The information about the tube can comprise: the internal radius, external radius, length, material, etc. The information about the transducer cylinder 514 can include: number of transducers rings, 310A and 310B; number of transducers on each ring, etc.

In some embodiments of the HHP 510 (FIG. 5), the interface between the transducer cylinder 514 and the housing 512 can include an indicator that indicates the number of rings and the number of transducers on each ring. The indicator can be electrical switches that can be set according to the configuration of the cylinder. In alternate embodiments the indicator can be an optical indicator having a combination of holes, or a printed code such as a barcode, a dip-switch, an RFID, a readable memory element, etc. The housing can include a reader that matches the method that was implemented for the indicator and can automatically read and load the configuration of the transducers cylinder 514 to the MPU 530.

After associating the TC 514 and the HHP housing 512, process 600 can verify 604 that the GW transducers 310A and 310B are at a non-active stage (NAS) as illustrated by FIG. 3A and FIG. 3B. In some embodiment the verification can be done manually by a human tester (a user). In such embodiments, process 600 can be configured to instruct the user 604 to check if the transducer rings are in the NAS and process 600 can wait to get a confirmation from the user. In other embodiment the TC 300 may include location indicators (not shown in the figures). The location indicators can point on the relative location between the transducers 310A and 310B and the main body 305. An example of location indicator can comprise an air pressure indicator that is configured to monitor the pressure in the balloon of the elevating mechanism 315.

Next at block 606 the TC 514 can be pushed toward the opening of the next tube to be tested. At block 608 the user can be instructed to associate the TC with the tube and to activate the elevating mechanism 315. The elevating mechanism 315 can increases the diameter of the virtual ring of the transducers in order to attach them to the internal wall of the inspected tube.

At block 610, process 600 may wait until the transducers reach the active stage (AS) location. In some embodiments, the indication can be obtained from measuring the air pressure in the balloon of the elevating mechanism. In other embodiments, the indication can be obtained from an encoder or a limit switch, etc. Yet in some embodiments the user can check from time to time whether the HHP 510 is caught by the tube or not.

After determining that the TC 514 and the tube are associated, which means that the transducer rings are at an active stage (AS), the tube inspection process can be initiated 614 and mechanical GW can be transmitted toward the tube wall and reflection of the GW from the tube wall can be obtained by the transducers 310A and 310B. At the end of the tube inspection process 620, the elevating mechanism can be activated 624 in the other direction in order to detach the transducers from the tube wall and reach the NAS.

Next process 600 may wait 630 to obtain an indication that the virtual rings of the transducers 310A and 310B are in the NAS, which means that the diameter of the VR of the transducers is substantially smaller than the diameter of the tube. The indication can be obtained in a similar way to the indication that is obtained in block 610. Then the elevating mechanism can be hold in it's position, the TC can be pulled out 634 from the inspected tube and process 600 can be terminated 640.

The above description is intended to be illustrative, and not restrictive. For example, the above-described embodiments may be used in combination with each other. Many other embodiments will be apparent to those of skill in the art upon reviewing the above description.

The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein”.

What is claimed is:

1. A hand-held probe (HHP) for inspecting a tube, the HHP comprising:
a transducer cylinder having a shape of a cylinder with a near end and a far end and comprising one or more transducer rings, wherein each transducer ring comprises two or more mechanical wave transducers and the diameter of the transducer cylinder, at least at the far end, is less than the internal diameter of a tube to be inspected such that the far end of the transducer cylinder can be inserted into the tube; and
a housing having an opening for receiving a near end of the transducer cylinder;
wherein, the transducer cylinder comprises an adjustable centering mechanism (ACM) that is configured to be adjusted such that a central axis of the transducer cylinder can be substantially aligned with a central axis of the inspected tube when the transducer cylinder is inside one end of the inspected tube.

2. The HHP of claim 1, wherein the ACM comprises a conical-centering mechanism (CCM) at the far end of the transducer cylinder.

3. The HHP of claim 2, wherein the CCM comprises a plurality of stepwise conical elements.

4. The HHP of claim 1, wherein the ACM comprises, at the far end of the transducer cylinder, three or more guides and a pushing screw.

5. The HHP of claim 4, wherein the pushing screw is configured to push the three or more guides in the radial direction toward an interior wall of the tube.

6. The HHP of claim 1, wherein each transducer ring comprises a flexible beam per each transducer of the relevant transducer ring; and
wherein the flexible beam is configured to carry its relevant transducer in substantially radial movement toward the tube wall or the central axis of the transducer cylinder by an elevating mechanism.

7. The HHP of claim 6, wherein the elevating mechanism is an inflatable element located between the transducer ring and the central axis of the transducer cylinder.

8. A method for associating a hand-held probe (HHP) with a tube such that the HHP can be utilized in inspecting the tube, the method comprising:
inserting a transducer cylinder (TC) of the HHP into an opening of a tube to be inspected, wherein the TC comprises two or more transducer rings wherein each transducer ring is associated with a plurality of mechanical wave transducers wherein the diameter of the transducer cylinder and each of the TR is less than the internal diameter of the tube;
utilizing an adjustable centering mechanism (ACM) to adjust a central axis of the transducer cylinder to be substantially aligned with a central axis of the inspected tube; and
commencing a tube inspection process.'

9. The method of claim 8, wherein the ACM comprises a conical-centering mechanism (CCM) at a far end of the transducer cylinder and the action of utilizing the ACM to adjust the central axis comprises inserting the conical-centering mechanism into the tube to be inspected until the edges of the conical-centering mechanism approximate an interior diameter of the tube to be inspected.

10. The method of claim 9, wherein the CCM comprises a plurality of stepwise conical elements.

11. The method of claim 8, wherein the ACM comprises, at the far end of the transducer cylinder, three or more guides and a pushing screw and the action of utilizing the ACM comprises activating the pushing screw.

12. The method of claim 8, wherein the ACM comprises, at the far end of the transducer cylinder, three or more guides and a pushing screw and the action of utilizing the ACM comprises activating the pushing screw to force the three or more guides towards the interior wall of the tube to be inspected.

13. The method of claim 8, wherein each transducer ring comprises a flexible beam per each transducer of the relevant transducer ring and further comprising the action of
actuating the flexible beam to carry its relevant transducer in substantially radial movement toward the tube wall or the central axis of the transducer cylinder by an elevating mechanism.

14. The method of claim 13, wherein the elevating mechanism is an inflatable element located between the transducer ring and the central axis of the transducer cylinder.

15. The method of claim 8, further comprising the actions of:
activating the adjustable centering mechanism (ACM) to move each of the transducers of each transducer rings in substantially radial movement toward a central axis of the TC; and
pulling the TC out of the tube.

16. The method of claim 9, further comprising the actions of:
interfacing the HHP to a processing unit;
activating the mechanical wave transducers; and
taking measurements and recording the measurements in a memory element associated with the processing unit.
